(19) United States
(12) Patent Application Publication
(10) Pub. No.: US 2002/0041454 A1
(43) Pub. Date: Apr. 11, 2002

(54) Motor vehicle rearview mirror

(76) Inventors: Richard Guttenberger, Greding (DE); Arno Schieweck, Kleinlangheim (DE)

Correspondence Address: JACOBSON HOLMAN PLLC, 400 SEVENTH STREET N.W., SUITE 600, WASHINGTON, DC, 20004, US

(21) Appl. No.: 09/973,007

(22) Filed: Oct. 10, 2001

(30) Foreign Application Priority Data
Oct. 10, 2000 (DE) 100 49 954.6

(51) Int. Cl. G02B 7/182

(52) U.S. Cl. 359/877; 359/871; 359/879

(57) ABSTRACT

A motor vehicle rearview mirror, comprising a mirror housing; a carrier, which is mounted therein and on which a mirror glass drive, which includes at least one drive motor and a downstream step down gear and with which a mirror glass carrier, which can be driven by the mirror glass drive, can be swiveled around two swivel axes, arranged at right angles to each other; and connections at least to supply at least one drive motor. At least the supply of at least one drive motor occurs by means of an electronic module, which is connected electrically to the mirror glass drive by means of at least one first output plug.

### BACKGROUND OF THE INVENTION

1. The Field of the Invention

The invention relates to a motor vehicle rearview mirror including a mirror housing on which is mounted a carrier. In turn, a mirror glass drive is positioned on the carrier. The carrier has at least one drive motor and a downstream step down gear. The mirror glass carrier, which can be driven by the mirror glass drive, can be swiveled around two swivel axes, arranged at right angles to each other. Further, there are connections at least to supply electrical current to at least one drive motor.

2. Description of Related Art

Co-pending U.S. patent application Ser. No. 09/559,398 discloses a mirror glass drive to which the present invention relates. This document describes the construction of the mirror glass drive and belongs explicitly to the present disclosure of this invention and is incorporated by reference herein as if reproduced in full.

In prior art motor vehicle rearview mirrors, all of the feed lines for the individual functional units, like the mirror glass drive, fold down drive, blinkers, surrounding field lighting, mirror heating unit, etc., are guided into the mirror by way of stranded cables as part of a cable harness. Usually control of the functional units takes place through a central electronic unit. Based on the increasing number of functional units that have to be housed in the motor vehicle rearview mirror, especially when equipping for comfort, it becomes increasingly more difficult to supply and drive these functional units.

To provide a solution to the problem, digital BUS controls have been proposed that make do with two supply lines and one data line. However, to this end each functional unit must have BUS electronics that recognizes the corresponding drive signals and enables the supply lines. In the case of standard accessories, the same parts, especially the same mirror glass drive, are used for economic reasons. To this end, a modular design that is as flexible as possible is necessary.

### BRIEF SUMMARY OF THE INVENTION

A primary object of the present invention is to design a motor vehicle rearview mirror in such a manner that it is economical to produce, exhibits good maintenance properties, can be wired inexpensively, provides good protection of the electronics against damage and environmental impact and exhibits a flexible, modular construction.

The present invention solves prior art problems in that the activation of at least one drive motor is accomplished by means of an electronic module, which is connected electrically to the mirror glass drive by means of at least one first output plug. Thus, it is possible to equip the motor vehicle rearview mirror alternatively with or without electronics. Hence, the mirror glass drive can be more economically produced in greater quantities. In addition, it is possible in the event of the mirror glass drive being damaged to replace only the drive, if the electronics are still useable.

For geometric reasons, it can be quite expedient to subdivide the first output plug into several individual plugs. Thus, the special geometric conditions of the mirror glass drive can be better considered.

It is advantageous to design the electronic module with at least one input plug for connection to the motor vehicle electrical system and other output plugs for electrical connection with functional units in or at the motor vehicle rearview mirror. In this way, the wiring expense in the motor vehicle rearview mirror can be significantly reduced.

Mounting the mirror glass drive on the electronic module is facilitated in that the plug contacts for making contact with the first output plug are disposed in such a manner at the mirror glass drive that they can be plugged at approximately right angles to the mirror glass carrier. In addition, one alternative is also to electrically connect the mirror glass drive to the carrier.

To achieve adequate strength between the mirror glass drive and electronic module, the electronic module is connected mechanically to the mirror glass drive. This connection can be done by snapping, screwing, riveting, cementing, or welding. Preferably the electronic module is connected in such a manner to the mirror glass drive that it can be disconnected, so that in the event of the mirror glass drive being damaged, the electronic module does not also have to be replaced. To protect the electronics, the electronic module is made up of a two part housing, defining a chamber for housing the electronics. In so doing, no liquids or salt fog can penetrate into the chamber in order to avoid corrosion.

The expense of putting wiring in the mirror is significantly reduced because the electronic module contains BUS electronics. To this end, the plug connections also have contacts for at least one data line.

The electronic module can also contain control electronics for diverse electrical devices, especially blinkers, mirror heaters, surrounding field lights, EC glass, etc. The advantage lies in the fact that the electronic module is disposed centrally in the motor vehicle rearview mirror and thus only short conducting paths have to be bridged.

Optimal use of the design space can be achieved by disposing the electronic module between the mirror glass drive 2 and the carrier 14. In this manner the electronic module 5 is also relatively well protected against damages.

To obtain optimally defined installation conditions, the electronic module is held exclusively at the mirror glass drive. Even vibrations between the electronic module and the carrier can be thus avoided, especially if it is guaranteed that there is space between these parts.

Assembly is simplified because the input plug is disposed in the carrier or a component of the carrier, especially if the plug in direction of the input plug essentially agrees with that of the first output plug.

### BRIEF DESCRIPTION OF THE DRAWINGS

FIG. 1 is an exploded drawing of an electronic module with a mirror glass drive.

FIG. 2 is an assembled drawing of the mirror glass drive with the electronic module; and

FIG. 3 is a simplified drawing of a motor vehicle rearview mirror of the invention.

### DETAILED DESCRIPTION OF THE INVENTION

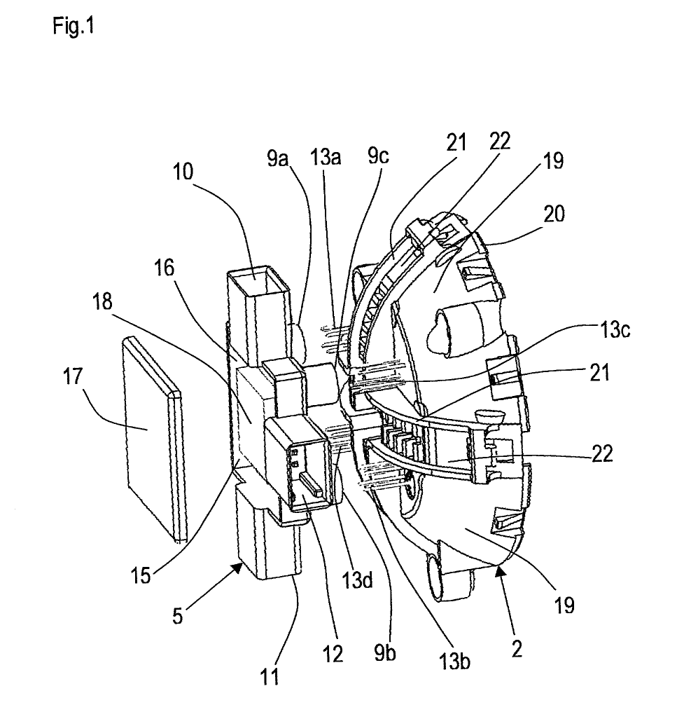

FIG. 1 is an exploded drawing of a mirror glass drive 2. The structure of such a mirror glass drive is explained in U.S. patent application Ser. No. 09/559,398 and, as mentioned before, is incorporated by reference herein as if reproduced in full. The mirror glass drive 2 consists of a first drive housing part 19 and a second drive housing part 20. Adjusting elements are formed on the first drive housing part 19, which is generally shaped like half a sphere, to define two swivel axes 7 and 8 arranged at right angles to each other. Guides 21 are defined in the first drive housing part 19 and border the adjusting elements 22. Plug contacts 13a, 13b, 13c, and 13d are arranged between the guides 21. An electronic module 5 is made up of a first housing part 16 that mates with a second housing part 17 (here designed as the cover). A first output plug is divided into four individual output plugs. Three of the output plugs 9a, 9b, 9c selectively mate with the plug contacts 13a, 13b, and 13c. A fourth output plug (not shown but referred to as output plug 9d) is positioned to make with contact 13d. The first output plug also includes a first input plug 12, a second output plug 10, and a third output plug 11. The second and third output plugs are opposed from each other generally along a single axis. The first input plug 12 is arranged generally at a right angle to the single axis.

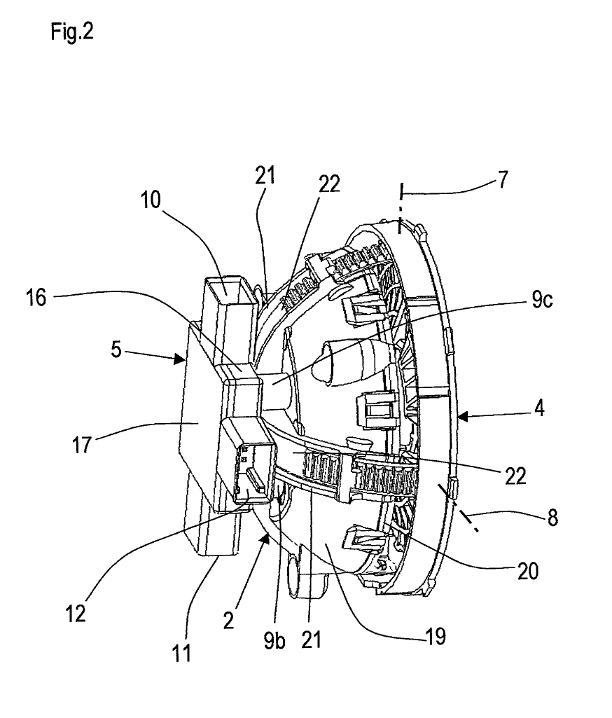

FIG. 2 is an assembled drawing of the mirror glass drive 2 with the adjusting elements 22 connected to a mirror glass carrier 4 so as to articulate. The first drive housing part 19 is connected to the second drive housing part 20. The guides 21 border the adjusting elements. The electronic module 5 which is constructed by the first housing part 16, the second housing part 17, the input plug 12, the second output plug 10, the third output plug 11 and the individual output plugs 9a-9d are connected to the mirror glass drive 2 to mate with the plug contacts 13a-13d.

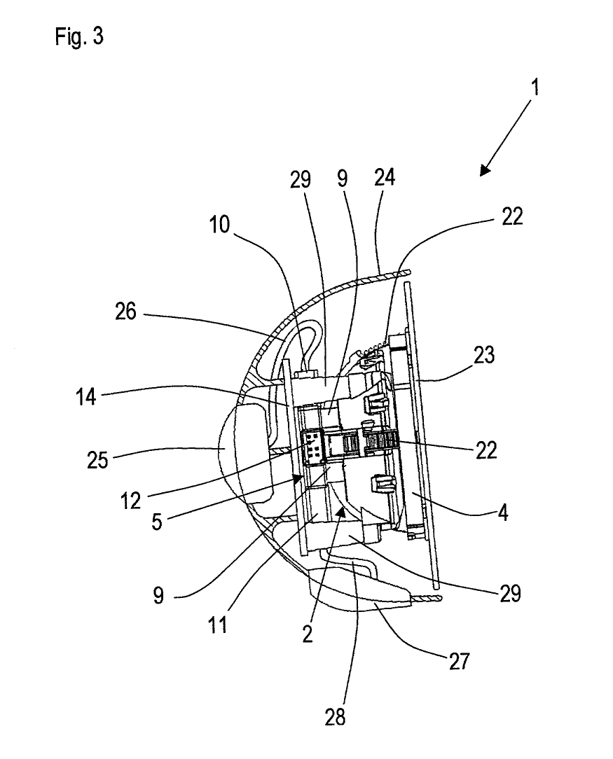

FIG. 3 is a simplified drawing of an inventive motor vehicle rearview mirror assembly 1 that includes a generally hollow hemispherical shaped mirror housing 24. Positioned within the housing 24 is the mirror glass drive 2, with the adjusting elements 22 and the mirror glass carrier 4, which carries a mirror glass 23, the electronic module 5, the input plug 12, the first individual output plugs 9a-9d, the second output plug 10, the third output plug 11, and a carrier 14. The mirror housing 24 has a blinker 25 mounted thereon. The blinker 25 is connected electrically to the second output plug 10 by means of electrical lines 26. Furthermore, the mirror housing 24 also includes a surrounding field lighting 27, which is connected electrically to the third output plug 11 by means of electrical lines 28. The mirror glass drive 2 on the carrier is attached by means of screw connections to the attachment posts 29, which are integral with the carrier 14.

The present invention may be embodied in other specific forms without departing from the intent or essential characteristics. The described embodiments are to be considered in all respects only as illustrative and not restrictive.

What is claimed is:

1. A motor vehicle rearview mirror comprising:
a mirror housing;
a mirror carrier mounted in the mirror housing;
a mirror glass drive secured to the mirror carrier, the mirror glass drive including at least one drive motor and a downstream step down gear;
a mirror glass carrier mounted to the mirror glass drive so that the mirror glass carrier is capable of being driven by the mirror glass drive about two swivel axes arranged at right angles to each other; and
electrical connections at least to supply the at least one drive motor, wherein the electrical connections are by way of an electronic module that is connected electrically to the mirror glass drive by means of at least one first output plug.

2. The motor vehicle rearview mirror, as claimed in claim 1, wherein the first output plug is subdivided into several individual plugs.

3. Motor vehicle rearview mirror, as claimed in claim 2, wherein the first output plug is subdivided into four individual plugs.

4. Motor vehicle rearview mirror, as claimed in claim 1, wherein the electronic module includes at least one input plug for the connection to a vehicle electrical system and a second output plug for making contact with functional units in or at the motor vehicle rearview mirror.

5. The motor vehicle rearview mirror, as claimed in claim 1, wherein the electronic module includes a third output plug for making contact with functional units in or at the motor vehicle rearview mirror.

6. The motor vehicle rearview mirror, as claimed in claim 1, wherein the electronic module includes more than three output plugs.

7. The motor vehicle rearview mirror, as claimed in claim 1, further comprising:
plug contacts for making contact with the first output plug, the plug contacts being disposed at the mirror glass drive so that they can be plugged at approximately right angles to the mirror glass carrier.

8. The motor vehicle rearview mirror, as claimed in claim 7, wherein the plug contacts are designed so that they can be plugged alternatively into a plug, which is disposed on the carrier.

9. The motor vehicle rearview mirror, as claimed in claim 1, further comprising:
means for mechanically connecting the electronic module to the mirror glass drive.

10. The motor vehicle rearview mirror, as claimed in claim 9, wherein the electronic module is connected to the mirror glass drive by snapping, screwing, riveting, cementing, or welding.

11. The motor vehicle rearview mirror, as claimed in claim 9, wherein the electronic module is connected to the mirror glass drive in such a manner that it can be disconnected.

12. The motor vehicle rearview mirror, as claimed in claim 1, wherein the electronic module comprises two housing parts defining a chamber.

13. The motor vehicle rearview mirror, as claimed in claim 1, further comprising:
BUS electronics in the electronic module.

14. The motor vehicle rearview mirror as claimed in claim 1, further comprising:
control electronics in said electronic module for powering diverse electrical devices.

15. The motor vehicle rearview mirror, as claimed in claim 1, wherein the electronic module is disposed between the mirror glass drive and the carrier.

16. The motor vehicle rearview mirror, as claimed in claim 1, wherein the electronic module is held mechanically exclusively at the mirror glass drive.

17. The motor vehicle rearview mirror, as claimed in claim 1, wherein the input plug is disposed in the carrier or a component of the carrier.

18. The motor vehicle rearview mirror, as claimed in claim 17, wherein the plug in direction of the input plug agrees in essence with that of the first output plug.
